(19) United States
(12) Patent Application Publication
(10) Pub. No.: US 2011/0030627 A1
(43) Pub. Date: Feb. 10, 2011

(54) CYLINDER CRANK CASE FOR AN INTERNAL COMBUSTION ENGINE

(76) Inventors: Karlheinz Bing, Remseck (DE); Frank Winger, Stuttgart (DE); Ulrich Bischofberger, Esslingen (DE); Stefan Spangenberg, Stuttgart (DE)

Correspondence Address: COLLARD & ROE, P.C., 1077 NORTHERN BOULEVARD, ROSLYN, NY, 11576, US

(21) Appl. No.: 12/733,390

(22) PCT Filed: Aug. 23, 2008
(86) PCT No.: PCT/DE2008/001393

§ 371 Date: Aug. 20, 2010

(30) Foreign Application Priority Data
Aug. 29, 2007 (DE) 10 2007 041 010.9

(51) Int. Cl. F02F 1/14; F02F 7/00

(52) U.S. Cl. 123/41.79; 123/195 R

(57) ABSTRACT

The invention relates to a cylinder crankcase (1) for an internal combustion engine, into which crankcase a one-piece cylinder jacket system (9) is diecast, the system comprising at least two cylinder jackets (5, 6, 7) that are arranged in a row and that are interconnected via webs (2, 3, 4). The aim of the invention is to provide a cylinder crankcase which can be produced at low cost and which comprises a cylinder jacket system that can be subjected to high thermal and mechanical stresses. According to the invention, a lateral face of the cylinder jacket system (9) has a rough structure and is surrounded by a diecast outer casing (26). Respective coolant passages (14, 15, 16) having openings (31, 32) for supplying and discharging the coolant are formed into the webs (2, 3, 4), at least one opening (32) extending through the outer casing (26) into the recess (25) for the water cooling jacket.

The invention relates to a cylinder crankcase for an internal combustion engine, in accordance with the preamble of claim 1.

A cylinder crankcase for an internal combustion engine, produced using the high-pressure die-casting method, is known from the PCT application WO 2004/009986 A1, into which crankcase a sleeve system is cast, which consists of multiple cylinder sleeves disposed in a row and connected with one another by way of webs. For cooling, cooling channels that are connected with one another are introduced into the cylinder sleeves and into the webs, forming a water jacket. It is disadvantageous, in this connection, for one thing, that the production of cylinder sleeves with cooling channels situated in them is very complicated. For another thing, cylinder sleeves, with channels introduced into their walls, can be used for casting into a cylinder crankcase to be produced using the high-pressure die-casting method only if the channels are filled with sand or salt during the high-pressure die-casting method, so that the cylinder sleeves, which have a very thin wall in the region of the channels, do not suffer any harm during casting.

Proceeding from this, the invention is based on the task of avoiding the disadvantages of the state of the art, and of creating a cylinder crankcase that can be produced in price-advantageous manner, having a sleeve system that can withstand great thermal and mechanical stress, to be cast into the cylinder crankcase using the high-pressure die-casting method.

This task is accomplished with the characteristics that stand in the characterizing part of the main claim. Practical embodiments of the invention are the object of the dependent claims.

In this connection, cylinder sleeves consisting of solid material, without channels introduced into their cylinder walls, are used, and these have a stable structure and can be produced in cost-advantageous manner. Furthermore, the rough structure of the radially outer side surface forms a seal, particularly in the region of the border surfaces between the webs and the outer casing, for the coolant passages that are passed through the webs and the outer casing in this region, to prevent exit of the cooling water.

Some exemplary embodiments of the invention will be described in the following, using the drawings. These show:

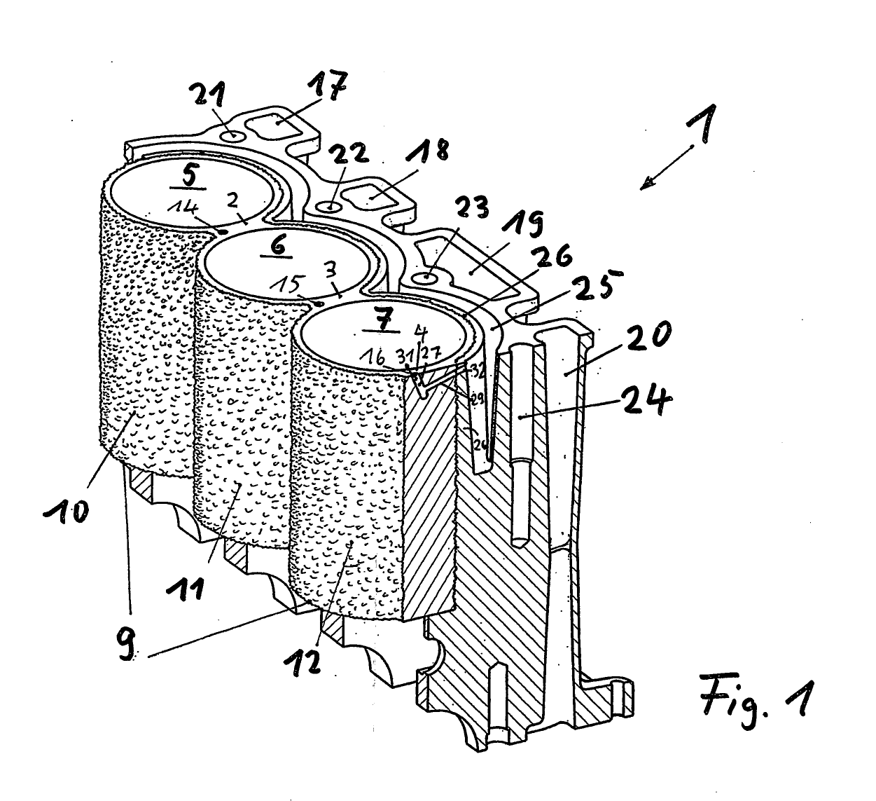

FIG. 1 a partly cut open cylinder crankcase with multiple cylinder sleeves disposed in the sleeve system,

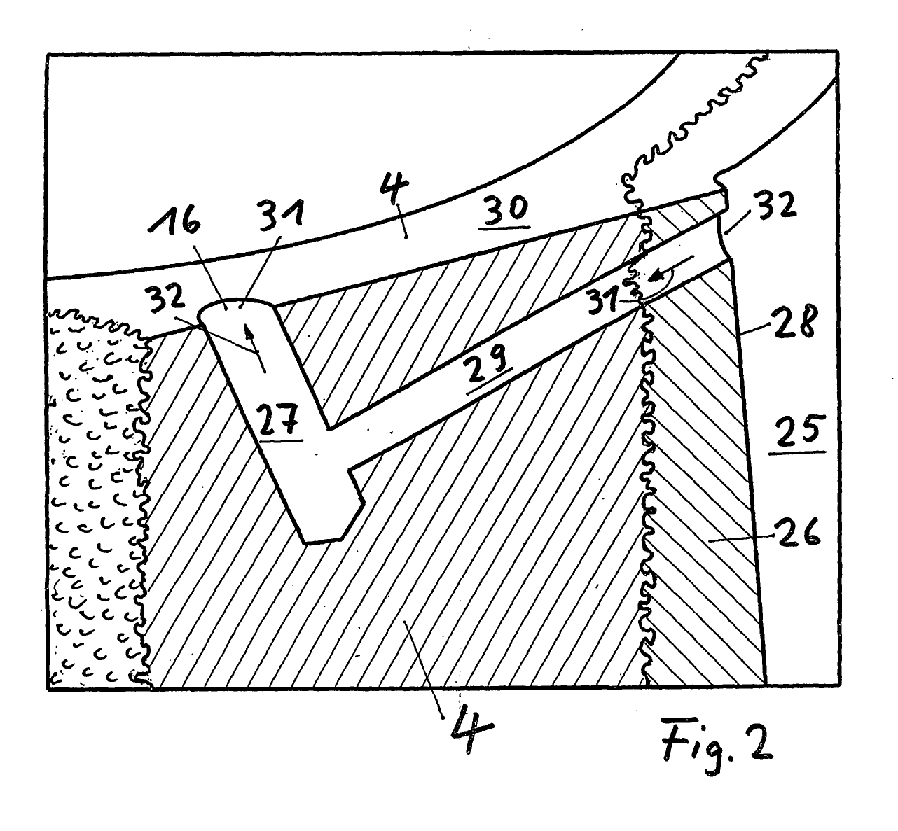

FIG. 2 an enlarged representation of an embodiment of a coolant passage consisting of two dead-end bores, and

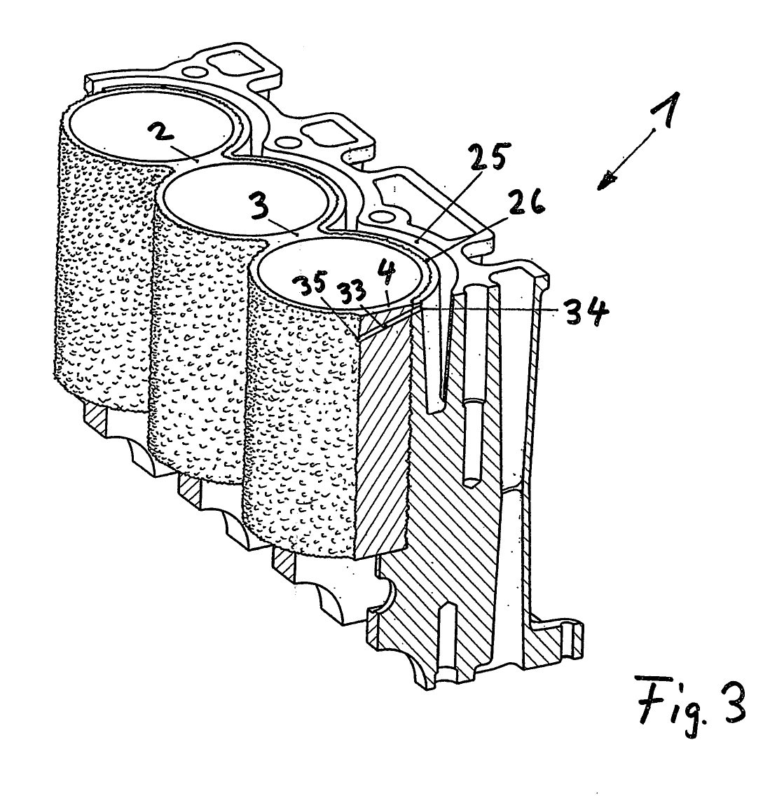

FIG. 3 another embodiment of a coolant passage consisting of a continuous bore, which is passed through the web and through the outer casing situated on both sides of the web.

In FIG. 1, a cylinder crankcase 1 is shown, which is partly cut open in the representation selected, whereby the cut surfaces are shown with cross-hatching. The cylinder crankcase 1 consists of a sub-eutectic aluminum/silicon alloy and is produced using the high-pressure die-casting method, whereby cylinder sleeves 5, 6, 7 are cast into the cylinder crankcase 1, as well, which are disposed in a row and connected with one another by way of webs 2, 3, 4, so that a sleeve system 9 is obtained. In the present, partly cut open representation of the cylinder crankcase, three cylinder sleeves 5, 6, 7 can be seen.

The cylinder crankcase 1 has oil reflux channels 17, 18, 19, 20 and furthermore screw-in bores 21, 22, 23, 24. Furthermore, a recess 25 for a water jacket is formed into the cylinder crankcase 1, by which jacket the cylinder sleeves 5, 6, 7 are surrounded for the purpose of cooling. On the side of the cylinder sleeves 5, 6, 7, the recess 25 is delimited by an outer casing 26, by which the cylinder sleeves 5, 6, 7 and the webs 2, 3, 4 disposed between them are surrounded, so that in the exemplary embodiment according to FIG. 1, dry cylinder sleeves 5, 6, 7 are present.

As can be seen particularly well in FIG. 2, the radially outer mantle surfaces 10, 11, 12 of the cylinder sleeves 5, 6, 7 have a rough structure with a depth between 0.2 mm and 1.5 mm, which has undercuts. In the present exemplary embodiment, the depth of the rough structure amounts to 0.5 mm, on average. Because of the rough structure of the mantle surfaces 10, 11, 12, a shape-fit and force-fit connection between the cylinder sleeves 5, 6, 7 and the outer casing 26 of the cylinder crankcase 1 is achieved.

The sleeve system 9 formed by the cylinder sleeves 5, 6, 7 is produced using the low-pressure permanent mold casting method or using the gravity casting method. For this purpose, a super-eutectic aluminum/silicon alloy is used, which contains not only aluminum but 15% to 21% silicon, 1% to 5% magnesium, and 2% to 5% copper. The aluminum/silicon alloy can furthermore contain 0.7% to 1.5% iron and 0.3% to 0.7% manganese.

For better cooling of the cylinder sleeves 5, 6, 7, coolant passages 14, 15, 16 are introduced into the webs 2, 3, 4.

The coolant passage 16 is shown enlarged in FIG. 2, and consists, as do the other coolant passages 14 and 15, of a first dead-end bore 27 introduced into the cylinder-head-side face 30 of the web 4, having an opening 31 in the cylinder-head-side face 30 of the web 4, and of a second dead-end bore 29 introduced into the web 4 from the cylinder-sleeve-side delimitation surface 28 of the recess 25, by way of the outer casing 26, having an opening 32 in the outer casing 26, whereby the two dead-end bores 27 and 29 are oriented in such a manner that the second dead-end bore 29 opens into the lower end of the first dead-end bore 27. In the present exemplary embodiment, the dead-end bores 27 and 29 have a diameter of 2.5 mm, whereby the width of the webs 2, 3, 4 amounts to 7 mm, in each instance.

The flow of the coolant, water, through the coolant passage 16 takes place (see FIG. 2) in the direction of the arrows 31 and 32 in the present exemplary embodiment, since in the finished, fully assembled internal combustion engine, whereby the cylinder head not shown in the figures is mounted on the cylinder crankcase 1, the pressure of the cooling water situated in the recess 25 is sufficiently great to drive part of the cooling water through the dead-end bores 29 and 27 and thus to cool the upper region of the web 4, which is the part of an internal combustion engine subject to the greatest thermal stress.

FIG. 3 shows an embodiment of the cylinder crankcase 1 in which the coolant passages 33 formed into the webs 2, 3, 4 have two openings 34, 35, both of which open into the recess 25 for the water jacket, by way of the outer casing 26. The coolant passages 14, 15, 16, and 33 as well as the dead-end bores 27 and 29 can be produced by means of erosion.

### REFERENCE SYMBOL LIST

1 cylinder crankcase
2, 3, 4 web
5, 6, 7 cylinder sleeve
9 sleeve system
10, 11, 12 mantle surfaces of the cylinder sleeves
14, 15, 16 coolant passage
17, 18, 19, 20 oil reflux channel
21, 22, 23, 24 screw-in bore
25 recess for a water jacket
26 outer casing
27 first dead-end bore
28 delimitation surface
29 second dead-end bore
30 face of the web 4
31, 32 opening of the coolant passage 16
33 coolant passage
34, 35 openings of the coolant passage 33

1. Cylinder crankcase (1) for an internal combustion engine, which consists of an aluminum/silicon alloy, and into which a sleeve system (9) consisting of one piece is cast, using the high-pressure die-casting method, which system consists of a super-eutectic aluminum/silicon alloy, and which has at least two cylinder sleeves (5, 6, 7) disposed in a row and connected with one another by way of webs (2, 3, 4), whereby the side surface of the sleeve system, composed in part of the radially outer mantle surfaces (10, 11, 12) of the cylinder sleeves (5, 6, 7) and in part by the adjacent surfaces of the webs (2, 3, 4) has a rough structure, wherein the side surface of the sleeve system (9) is surrounded by an outer casing (26) formed by the cylinder crankcase (1), which delimits a recess (25) for a water jacket formed into the cylinder crankcase (1) on the cylinder sleeve side, and wherein at least one coolant passage (14, 15, 16, 33), in each instance, is introduced into the webs (2, 3, 4), having openings (31, 32, 34, 35) for entry and exit of the coolant, whereby at least one opening (32, 34, 35) opens into the recess (25) for the water jacket, by way of the outer casing (26).

2. Cylinder crankcase (1) according to claim 1, wherein the coolant passage (33) has two openings (34, 35) that both open into the recess (25) for the water jacket, by way of the outer casing (26).

3. Cylinder crankcase (1) according to claim 1, wherein the coolant passage (14, 15, 16) has two openings (31, 32), of which one opening (31) opens into the cylinder-head-side face of the web (2, 3, 4), in each instance, and the other opening (32) opens into the recess (25) for the water jacket, by way of the outer casing (26).

4. Cylinder crankcase (1) according to claim 3, wherein the coolant passages (14, 15, 16) consist, in each instance, of a first dead-end bore (27) introduced into the cylinder-head-side face (30) of the web (2, 3, 4), in each instance, and of a second dead-end bore (29) introduced into the web (2, 3, 4), in each instance, from the cylinder-sleeve-side delimitation surface (28) of the recess (25) for the water mantle, by way of the outer casing (26), whereby the first and the second dead-end bore (27, 29) are disposed in such a manner that the bore end of the first dead-end bore (27) opens into the bore end of the second dead-end bore (29).

5. Cylinder crankcase (1) according to claim 4, wherein the diameters of the first and second dead-end bores (27, 29) amount to 2 to 4 mm, and the widths of the webs (2, 3, 4) amount to 5 to 8 mm.

6. Cylinder crankcase (1) according to claim 1, wherein the coolant passages (14, 15, 16, 33) are produced by means of erosion.

7. Cylinder crankcase (1) according to claim 1, wherein the aluminum/silicon alloy of which the sleeve system (9) consists contains 15% to 21% silicon, 1% to 5% magnesium, and 2% to 5% copper, and otherwise aluminum.

8. Cylinder crankcase (1) according to claim 7, wherein the aluminum/silicon alloy additionally contains 0.7% to 1.5% iron and 0.3% to 0.7% manganese.

9. Cylinder crankcase (1) according to claim 1, wherein the radially outer mantle surfaces (10, 11, 12) of the cylinder sleeves (5, 6, 7) have a rough structure having a depth between 0.2 mm and 1.5 mm and having undercuts.
